(19) United States
(12) Patent Application Publication
(10) Pub. No.: US 2026/0200545 A1
(43) Pub. Date: Jul. 16, 2026

(54) ADJUSTABLE SEAT POST OF BICYCLE

(71) Applicant: CRANKING SOLUTIONS CO., LTD., Tainan City (TW)

(72) Inventor: CHIEN-CHIH HOU, Tainan City (TW)

(21) Appl. No.: 19/015,692

(22) Filed: Jan. 10, 2025

(51) Int. Cl. B62J 1/08

(52) U.S. Cl. CPC B62J 1/08; B62J 2001/085

(57) ABSTRACT

An adjustable seat post of a bicycle includes a sliding tube including a top saddle support and a seat secured to an inner surface of the sliding tube; a hollow plunger in the sliding tube for dividing inside of the sliding tube into a first chamber filled with hydraulic fluid and a second chamber filled with both hydraulic fluid and pressurized air, the hollow plunger including a top opening communicating with the second chamber, and two opposite apertures through the hollow plunger and communicating with the top opening and the first chamber respectively; and a valve stem through the top opening and including an obstruction which may move to cause the obstruction to close or open the top opening. The top opening has a conic surface. The obstruction includes a conic surface. The two conic surfaces form an airtight seal when the top opening is closed.

### FIELD OF THE INVENTION

The invention relates to bicycle parts and more particularly to a hydraulic and pneumatic hybrid adjustable seat post of a bicycle having improved characteristics including decreased wear and prolonged useful life.

### BACKGROUND OF THE INVENTION

A conventional hydraulic and pneumatic hybrid seat post of a bicycle is shown in FIGS. 1 and 2 and comprises a sliding tube 10 having a lower end slidably disposed in a seat tube (not shown) of a bicycle, a saddle support 11 disposed at an upper end of the sliding tube 10 and provided with a saddle (not shown) disposed thereon, a support tube 15 disposed in the sliding tube 10 and having an upper end secured to the saddle support 11, the support tube 15 including two opposite first apertures 150 in a lower portion, a seat 12 fastened between lower portions of the support tube 15 and the sliding tube 10, a first chamber A disposed in the support tube 15 and filled with hydraulic fluid, a cylindrical second chamber B disposed between the sliding tube 10 and the support tube 15 and filled with hydraulic fluid, a separation member 16 fastened between the support tube 15 and the sliding tube 10 above the first apertures 150 for separating hydraulic fluid in the second chamber B from pressurized air also in the second chamber B, a height adjustment device 2 disposed in the support tube 15 and including a hollow plunger 20 for dividing the first chamber A into a first space A1 and a second space A2 communicating with the second chamber B through the first apertures 150, a valve stem 25 slidably disposed in the hollow plunger 20, a tubular member 22 having an upper portion secured to an inner surface of the lower portion of the hollow plunger 20 and a lower portion passing through the seat 12, a cylindrical cavity 21 around a lower portion of the valve stem 25 with the tubular member 22 disposed in a lower portion wherein the space of the cylindrical cavity 21 is configured to change as the valve stem 25 moves up or down, an opening 23 formed on a top of the hollow plunger 20 communicating with the first space A1, two opposite second apertures 24 formed through an upper portion of the hollow plunger 20 and communicating with the second space A2, an obstruction 26 formed on a top of the valve stem 25, an O-ring seal 27 disposed on an upper portion of the obstruction 26 and having a diameter slight greater than that of the opening 23, and a sliding rod 28 slidably disposed in the tubular member 22 and having a top urging against a bottom of the valve stem 25.

In a first operation, the sliding rod 28 is activated by pressurized hydraulic fluid from a hydraulic source (not shown) to move upward to disengage the obstruction 26 from the opening 23 in an open position P2 of the hollow plunger 20 (see FIG. 2). To the contrary, in a second operation, the pressurized hydraulic fluid is relieved so that the obstruction 26 may move downward to close the opening 23 with the help of the O-ring seal 27 in a closed position P1 of the hollow plunger 20 (see FIG. 1). Also, the sliding rod 28 moves downward to its original position. In either operation, volume of the hydraulic fluid in the first chamber A and the second chamber B may be changed and pressurized air in the second chamber B may be compressed or not, thereby adjusting height of the seat post.

However, the conventional hydraulic and pneumatic hybrid seat post has a number of drawbacks as detailed below. The O-ring seal 27 is the core of whether the opening 23 can be sealed. Unfortunately, the O-ring seal 27 is made of rubber and is subject to wear after a period of time of use. Further, the O-ring seal 27 may gradually deteriorate due to put under the hydraulic fluid. Furthermore, it is difficult to replace the malfunctioned O-ring seal 27 with a new one due to complicated components of the seat post. Moreover, filling hydraulic fluid and adjusting pressure of the stored hydraulic fluid are typically done by a technician and this may greatly increase the cost. It is often that the malfunction seat post is discarded. This is a waste due to short useful life.

Thus, the need for improvement still exists.

### SUMMARY OF THE INVENTION

It is therefore one object of the invention to provide an adjustable seat post of a bicycle, comprising a sliding tube including a saddle support at an upper end and a seat secured to an inner surface of a lower portion of the sliding tube; a hollow plunger slidably disposed in the sliding tube for dividing inside of the sliding tube into a first chamber filled with hydraulic fluid and a second chamber filled with both hydraulic fluid and pressurized air, the hollow plunger including an opening on a top, the opening communicating with the second chamber, and two opposite apertures formed through the hollow plunger and communicating with the opening and the first chamber respectively; and a valve stem slidably disposed through the opening of the hollow plunger and including an obstruction on a top, the valve stem being configured to move to cause the obstruction to close the opening of the hollow plunger in a closed position or open the opening of the hollow plunger in an open position; wherein the opening of the hollow plunger is provided with a conic surface; a diameter of the obstruction is greater than that of the opening of the hollow plunger; the obstruction includes a conic surface on a bottom; the valve stem is made of a first material having a first hardness and the hollow plunger is made of a second material having a second hardness less than the first hardness; and the conic surface of the obstruction is configured to complementarily dispose in the conic surface of the top opening of the hollow plunger, thereby forming an airtight seal therebetween, increasing wear resistance of both the obstruction and the hollow plunger, and increasing a useful life of each of the obstruction and the hollow plunger.

Preferably, further comprises a tubular member secured to an inner surface of the hollow plunger and passing through the seat, and a sliding rod slidably disposed in the tubular member and having a top urging against a bottom of the valve stem so that the valve stem is configured to move relative to the hollow plunger.

Preferably, the valve stem is made of metal and the hollow plunger is made of thermoplastic having a hardness less than that of the obstruction.

Preferably, the hollow plunger is made of metal and the valve stem is made of thermoplastic having a hardness less than that of the obstruction.

Preferably, the thermoplastic is polyoxymethylene (POM).

Preferably, further comprises a disk-shaped washer attached to the opening of the hollow plunger, the washer including a conic surface therethrough, the obstruction includes a conic surface configured to complementarily dispose in the conic surface of the washer.

Preferably, the hollow plunger further comprises a hollow cylinder disposed at the opening, an annular flange formed on a top of the hollow cylinder, and a hollow member secured to the annular flange, the disk-shaped washer is attached to a bottom of the hollow cylinder.

Preferably, the annular flange includes internal threads and the hollow member includes external threads threadedly secured to the internal threads.

Preferably, the hollow member further comprises an axial channel for flowing the hydraulic, and a tool is configured to drive into the axial channel to rotate the hollow member.

Preferably, the obstruction is made of metal and the disk-shaped washer is made of thermoplastic having a hardness less than that of the obstruction.

Preferably, the disk-shaped washer is made of metal and the obstruction is made of thermoplastic having a hardness less than that of the disk-shaped washer.

The above and other objects, features and advantages of the invention will become apparent from the following detailed description taken with the accompanying drawings.

### BRIEF DESCRIPTION OF THE DRAWINGS

FIG. 1 is a longitudinal sectional view of a conventional hydraulic and pneumatic hybrid seat post, the height adjustment device being in a closed position;

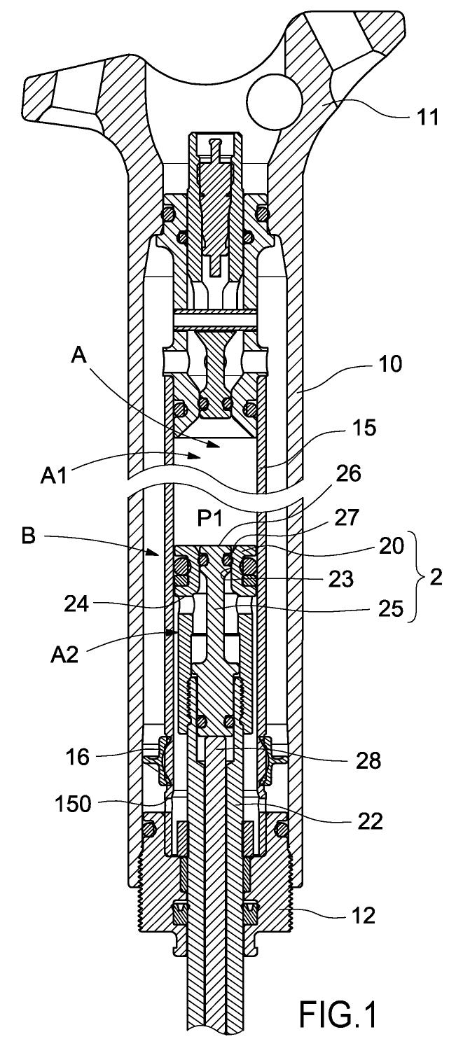

FIG. 2 is a view similar to FIG. 1, the height adjustment device being in an open position;

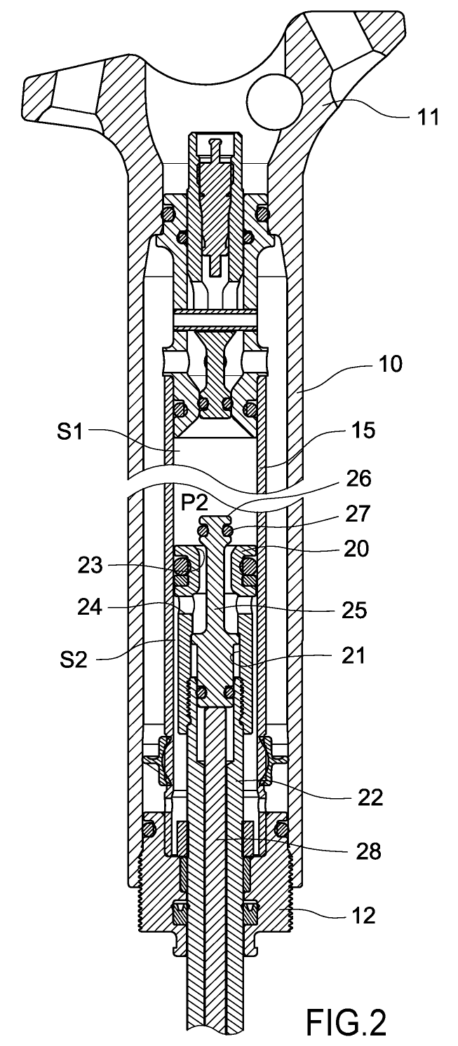

FIG. 3 is a perspective view of an adjustable seat post of bicycle according to a first preferred embodiment of the invention;

FIG. 4 is an exploded view of the adjustable seat post;

FIG. 5 is a longitudinal sectional view of the adjustable seat post, the height adjustment device being in a closed position;

FIG. 6 is a view similar to FIG. 5, the height adjustment device being in an open position;

FIG. 7 is an exploded view of an adjustable seat post of bicycle according to a second preferred embodiment of the invention; and

FIG. 8 is a longitudinal sectional view of the adjustable seat post in FIG. 7, the height adjustment device being in a closed position; and

FIG. 9 is a view similar to FIG. 8, the height adjustment device being in an open position.

### DETAILED DESCRIPTION OF THE INVENTION

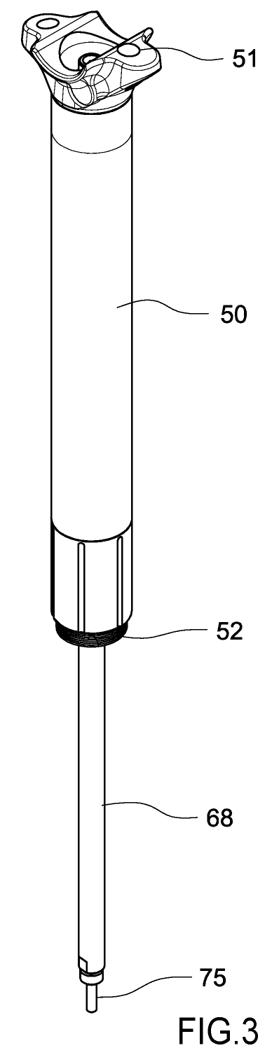

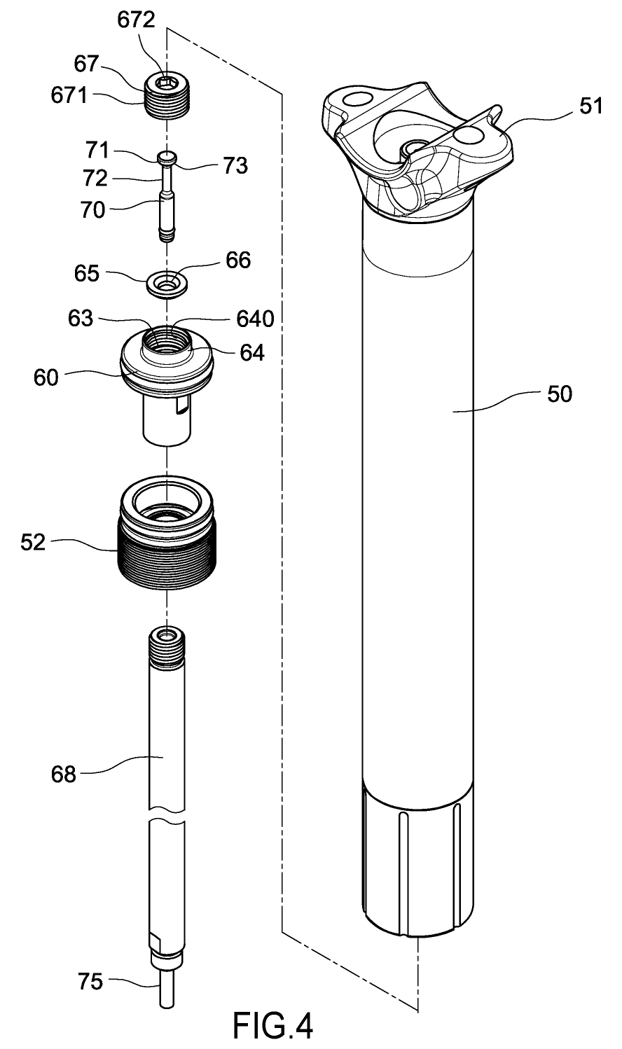

Referring to FIGS. 3 to 6, an adjustable seat post of bicycle in accordance with a first preferred embodiment of the invention comprises a sliding tube 50, a hollow plunger 60 slidably disposed in the sliding tube 50, and a valve stem 70 slidably disposed in the hollow plunger 60 as discussed in detail below.

The sliding tube 50 has a lower end slidably disposed in a seat tube (not shown) of a bicycle. A saddle support 51 is disposed at an upper end of the sliding tube 50 and provided with a saddle (not shown) disposed thereon. A seat 52 is fastened between a bottom of the hollow plunger 60 and an inner surface of a lower portion of the sliding tube 50.

A cylindrical first chamber A is formed by the hollow plunger 60, the sliding tube 50, and the seat 52. A second chamber B is formed by the hollow plunger 60, the sliding tube 50, and the saddle support 51. The first chamber A is filled with hydraulic fluid. The hydraulic fluid can be fed from a bottom of the second chamber B into the second chamber B and pressurized air can be fed into the second chamber B from a bottom of the saddle support 51. An opening 61 is formed through a top of the hollow plunger 60 and communicates with the second chamber B. Two opposite apertures 62 are formed through an intermediate portion of the hollow plunger 60 and communicate with the opening 61 and the first chamber A respectively. The hydraulic fluid in the first chamber A can communicate with the hydraulic fluid in the second chamber B through the apertures 62 and the opening 61. A tubular member 68 is threadedly secured to an internally threaded inner surface of the hollow plunger 60 and passes through the seat 52.

The valve stem 70 includes an obstruction 71 moveably disposed at the opening 61 of the hollow plunger 60 so as to open or close the opening 61 in operation. A sliding rod 75 is slidably disposed in the tubular member 68 and has a top urging against a bottom of the valve stem 70.

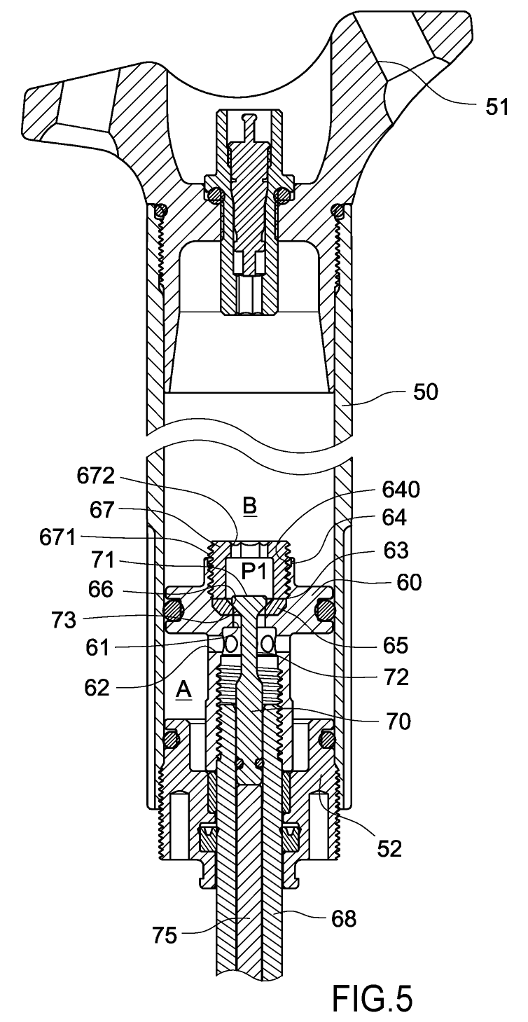

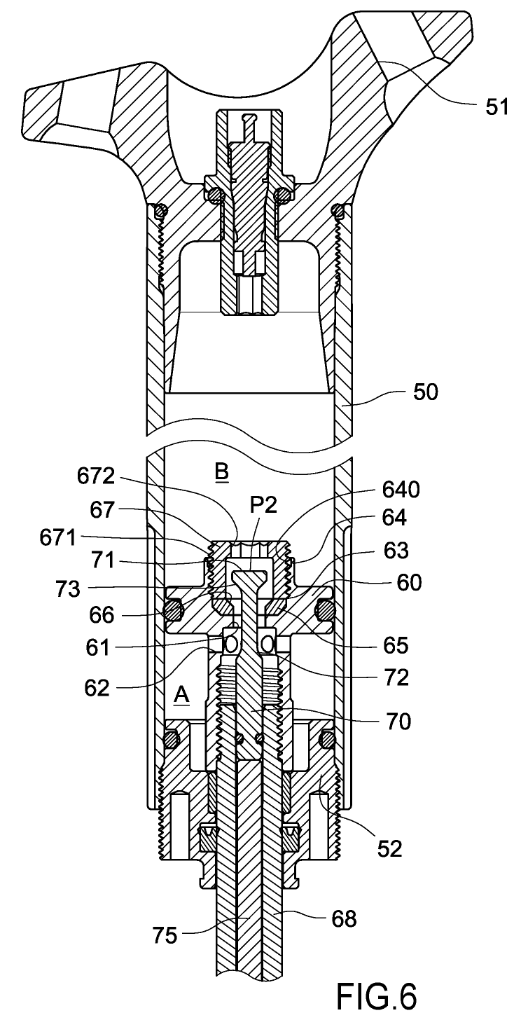

In a first operation, the sliding rod 75 is activated by pressurized hydraulic fluid from a hydraulic source (not shown) to move upward to disengage the obstruction 71 from the opening 61 in an open position P2 of the hollow plunger 60 (see FIG. 6). To the contrary, in a second operation, the pressurized hydraulic fluid is relieved so that the obstruction 71 may downward to close the opening 61 in a closed position P1 of the hollow plunger 60 (see FIG. 5). Also, the sliding rod 75 moves downward to its original position. In either operation, volume of the hydraulic fluid in the first chamber A and the second chamber B may be changed and pressurized air in the second chamber B may be compressed or not, thereby adjusting height of the seat post.

Characteristics of the invention are detailed below. A hollow cylinder 63 is disposed at the opening 61 of the hollow plunger 60. An annular flange 64 having internal threads 640 is formed on a top of the hollow cylinder 63. A hollow member 67 has external threads 671 which are threadedly secured to the internal threads 640. An axial channel 672 is formed through the hollow member 67. A tool can be driven into the axial channel 672 to rotate the hollow member 67. Further, the hydraulic fluid may flow through the axial channel 672. A disk-shaped washer 65 is attached to the opening 61 of the hollow plunger 60 and also attached to a bottom of the hollow cylinder 63. The washer 65 has a conic surface 66 on its hole. The obstruction 71 includes a conic surface 73 which is configured to complementarily dispose in the conic surface 66. A diameter of the obstruction 71 is greater than that of the opening 61. The valve stem 70 includes an intermediate neck 72 disposed between the apertures 62 so that the hydraulic fluid may flow from one aperture 62 to the other aperture 62 around the neck 72. The washer 65 is made of one material having a first hardness and the obstruction 71 is made of the other material having a second hardness greater than the first hardness. For example, the obstruction 71 is metal and the washer 65 is made of thermoplastic such as polyoxymethylene (POM). Alternatively, the washer is metal and the obstruction 71 is made of thermoplastic such as POM. In either case, the obstruction 71 and the washer 65 form an airtight seal therebetween. This is because the hardness of the obstruction 71 is different from that of the washer 65. Preferably, the washer 65 or the obstruction 71 made of POM has improved wear resistance and in turn has an increased useful life.

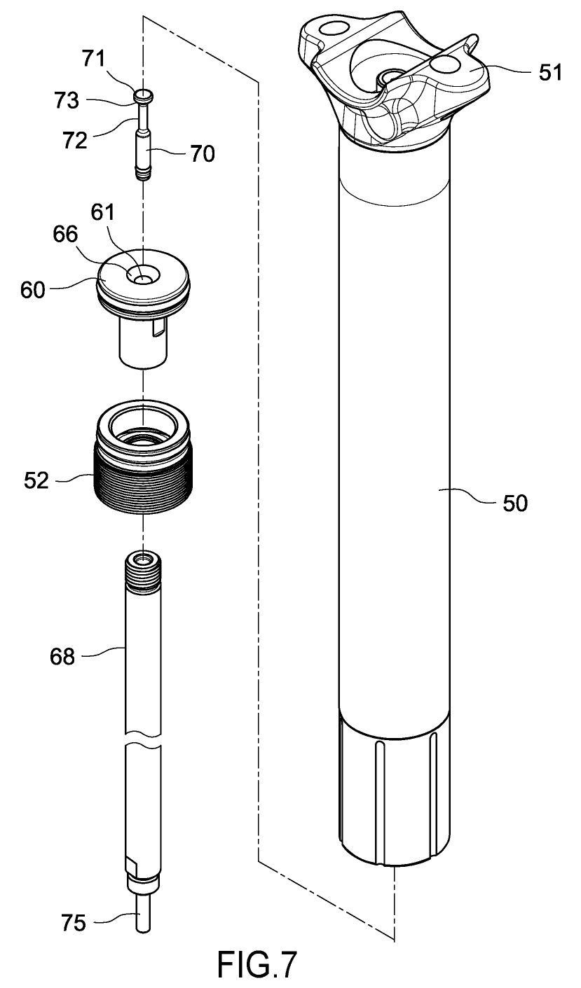

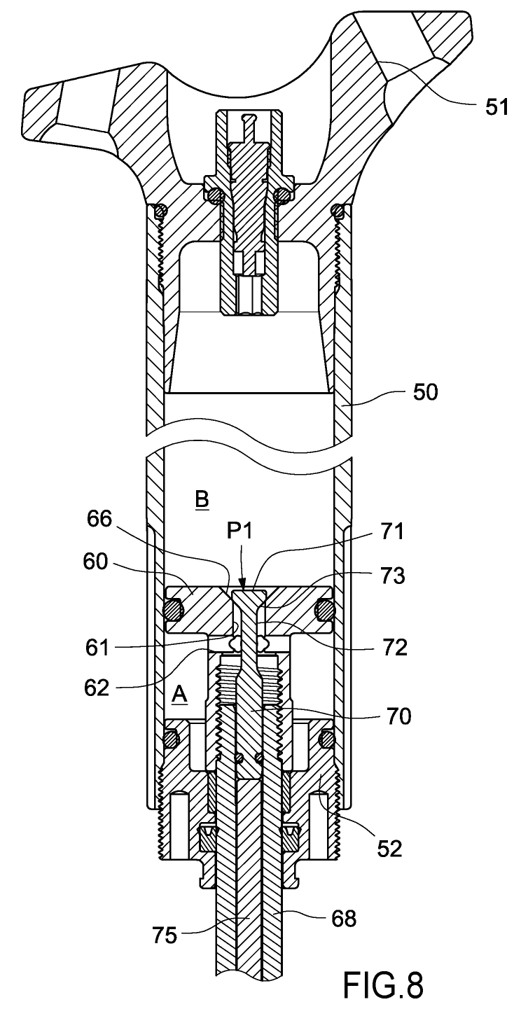

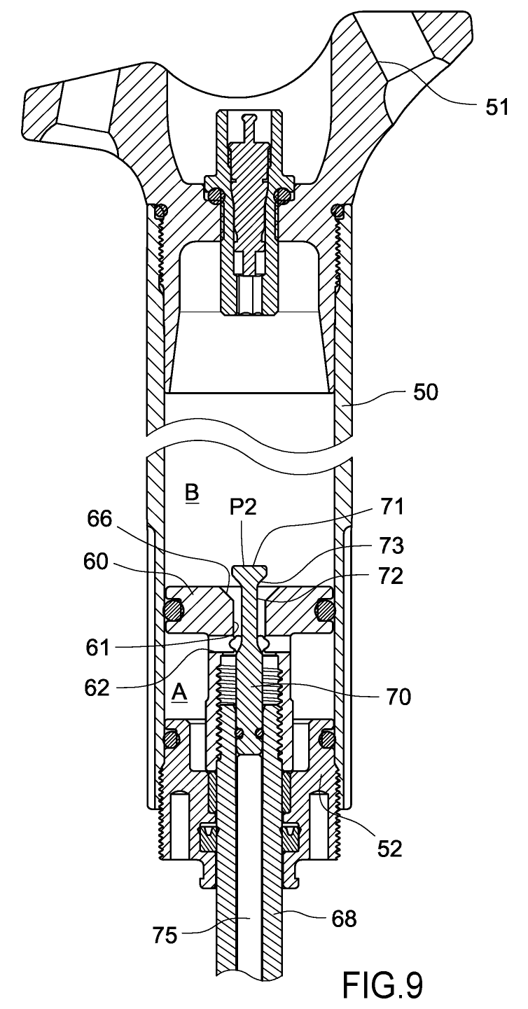

Referring to FIGS. 7 to 9, an adjustable seat post of bicycle in accordance with a second preferred embodiment of the invention is shown. The characteristics of the second preferred embodiment are substantially the same as that of the first preferred embodiment except the following: the opening 61 has a conic surface 66. A diameter of the obstruction 71 is greater than that of the opening 61. The obstruction 71 includes a conic surface 73 on a bottom. The conic surface 73 is configured to complementarily dispose in the conic surface 66. The hollow plunger 60 is made of one material having a first hardness and the valve stem 70 is made of the other material having a second hardness greater than the first hardness. For example, the valve stem 70 is metal and the hollow plunger 60 is made of thermoplastic such as POM. Alternatively, the hollow plunger 60 is metal and the valve stem 70 is made of thermoplastic such as POM. In either case, the valve stem 70 and the hollow plunger 60 form an airtight seal therebetween. This is because the hardness of the valve stem 70 is different from that of the hollow plunger 60. Preferably, the hollow plunger 60 or the valve stem 70 made of thermoplastic has improved wear resistance and in turn has an increased useful life.

While the invention has been described in terms of preferred embodiments, those skilled in the art will recognize that the invention can be practiced with modifications within the spirit and scope of the appended claims.

What is claimed is:

1. A seat post of a bicycle, comprising:
a sliding tube including a saddle support at an upper end and a seat secured to an inner surface of a lower portion of the sliding tube;
a hollow plunger slidably disposed in the sliding tube for dividing inside of the sliding tube into a first chamber filled with hydraulic fluid and a second chamber filled with both hydraulic fluid and pressurized air, the hollow plunger including an opening on a top, the opening communicating with the second chamber, and two opposite apertures formed through the hollow plunger and communicating with the opening and the first chamber respectively; and
a valve stem slidably disposed through the opening of the hollow plunger and including an obstruction on a top, the valve stem being configured to move to cause the obstruction to close the opening of the hollow plunger in a closed position or open the opening of the hollow plunger in an open position; wherein:
the opening of the hollow plunger is provided with a conic surface;
a diameter of the obstruction is greater than that of the opening of the hollow plunger;
the obstruction includes a conic surface on a bottom;
the valve stem is made of a first material having a first hardness and the hollow plunger is made of a second material having a second hardness less than the first hardness; and
the conic surface of the obstruction is configured to complementarily dispose in the conic surface of the top opening of the hollow plunger, thereby forming an airtight seal therebetween, increasing wear resistance of both the obstruction and the hollow plunger, and increasing a useful life of each of the obstruction and the hollow plunger.

2. The seat post of claim 1, further comprising a tubular member secured to an inner surface of the hollow plunger and passing through the seat, and a sliding rod slidably disposed in the tubular member and having a top urging against a bottom of the valve stem so that the valve stem is configured to move relative to the hollow plunger.

3. The seat post of claim 1, wherein the valve stem is made of metal and the hollow plunger is made of thermoplastic having a hardness less than that of the obstruction.

4. The seat post of claim 1, wherein the hollow plunger is made of metal and the valve stem is made of thermoplastic having a hardness less than that of the obstruction.

5. The seat post of claim 3, wherein the thermoplastic is polyoxymethylene (POM).

6. The seat post of claim 1, further comprising a disk-shaped washer attached to the opening of the hollow plunger, the washer including a conic surface therethrough, wherein the obstruction includes a conic surface configured to complementarily dispose in the conic surface of the washer.

7. The seat post of claim 6, wherein the hollow plunger further comprises a hollow cylinder disposed at the opening, an annular flange formed on a top of the hollow cylinder, and a hollow member secured to the annular flange, wherein the disk-shaped washer is attached to a bottom of the hollow cylinder.

8. The seat post of claim 6, wherein the annular flange includes internal threads and the hollow member includes external threads threadedly secured to the internal threads.

9. The seat post of claim 6, wherein the hollow member further comprises an axial channel for flowing the hydraulic, and wherein a tool is configured to drive into the axial channel to rotate the hollow member.

10. The seat post of claim 6, wherein the obstruction is made of metal and the disk-shaped washer is made of thermoplastic having a hardness less than that of the obstruction.

11. The seat post of claim 6, wherein the disk-shaped washer is made of metal and the obstruction is made of thermoplastic having a hardness less than that of the disk-shaped washer.
